(19) United States
(12) Patent Application Publication
(10) Pub. No.: US 2026/0030651 A1
(43) Pub. Date: Jan. 29, 2026

(54) SYSTEM TO STREAM REAL TIME EVENTS FROM A PUBLISHER WEBPAGE TO ENABLE REAL WORLD PURCHASE BASED ATTRIBUTION

(71) Applicant: Catalina Marketing Corporation, St. Petersburg, FL (US)

(72) Inventors: Zubin SINGH, Cupertino, CA (US); James ZINKOVITCH, Holiday, FL (US); Robert SCHROETER, Pembroke, MA (US); Kirk DIKUN, Tampa, FL (US); Roberto VILLAGARCIA, Tampa, FL (US); Jan SRNICEK, St. Petersburg, FL (US)

(21) Appl. No.: 18/998,825

(22) PCT Filed: Jul. 27, 2023
(86) PCT No.: PCT/US2023/028831

§ 371 Date: Jan. 27, 2025

Related U.S. Application Data
(60) Provisional application No. 63/392,624, filed on Jul. 27, 2022.

(51) Int. Cl. G06Q 30/0242; G06Q 30/0241; G06Q 30/0601

(52) U.S. Cl. CPC G06Q 30/0242; G06Q 30/0277; G06Q 30/0641

(57) ABSTRACT

A method to track and a consumer-product interaction is provided. The method includes accessing a website viewed remotely, via a client device, by a user, identifying a sponsored advertisement payload on the website, the sponsored advertisement pay load associated with a featured product, determining that the user has interacted with the sponsored advertisement pay load, creating, in a server, a register associating the sponsored advertisement payload, the featured product, and the user, identifying a transaction by the user associated with the featured product, and updating an attribute of the sponsored advertisement pay load based on the transaction. A system including a memory storing instructions and a processor to execute the instructions and cause the system to perform the above method are also provided.

### CROSS-REFERENCE TO RELATED APPLICATIONS

The present disclosure is related and claims priority under 35 § 119 (e) to U.S. Prov. Appln. No. 63/392,624, entitled SYSTEM TO STREAM REAL TIME EVENTS FROM A PUBLISHER WEBPAGE TO ENABLE REAL WORLD PURCHASE BASED ATTRIBUTION, to Zubin SINGH et-al. filed on Jul. 27, 2022, the contents of which are hereafter incorporated by reference in their entirety, for all purposes.

### BACKGROUND

### Field

The present disclosure generally relates to tracking sponsored digital media advertisement customer exposures within a retailer's digital retail media network via mobile, desktop computer, and broadly web enabled devices.

### Description of the Related Art

Consumer Packaged Goods (CPG) brands lose about one-third of their consumers every year due mainly to the inefficient advertising techniques and a failure to precisely track advertising media effectiveness. To improve efficiency, marketing tools available today involve a trade-off between sophistication, selectivity, scalability, and accessibility (e.g., mobile, online, or in-store). However, sophisticated tools involve a heterogeneous mosaic of consumer-product interaction events that is hard to track and correlate. For example, some consumers may watch an advertisement on a billboard, then online while browsing a retail website, and finally make a purchase days or weeks later at a brick-and-mortar retail store. Current advertising campaigns are not configured to handle such complexity of tracking individual consumer media exposure events related to the consumer and tie this to the purchasing side of the equation to close-the-loop in a scalable and efficient manner.

### SUMMARY

In a first embodiment, a computer-implemented method includes accessing a website viewed remotely, via a client device, by a user, identifying a sponsored advertisement payload in the website, the sponsored advertisement payload associated with a featured product, determining that the user has interacted with the sponsored advertisement payload, creating, in a server, a register associating the sponsored advertisement payload, the featured product, and the user identifying a transaction by the user associated with the featured product, and updating an attribute of the sponsored advertisement payload based on the transaction.

In a second embodiment, a system includes a memory storing multiple instructions and one or more processors configured to execute the instructions and cause the system to perform operations. The operations include to access a website viewed remotely, via a client device, by a user, identify a sponsored advertisement payload in the website, the sponsored advertisement payload associated with a featured product, determine that the user has interacted with the sponsored advertisement payload, create, in a server, a register associating the sponsored advertisement payload, the featured product, and the user, identify a transaction by the user associated with the featured product, and update an attribute of the sponsored advertisement payload based on the transaction.

In a third embodiment, a computer-implemented method includes providing a digital sponsored advertisement event exposure payload to a remote server via a publisher server having an integrated media measurement software development kit, wherein the publisher server hosts a website that users access via a network with client devices and the digital sponsored advertisement event exposure payload includes a featured product sensitive to user interactions, generating a register when a user activates a trigger, wherein the register links the user, the remote server, and the featured product, and updating the register when a transaction associated with the featured product and the user is identified.

In yet other embodiments, a system includes a first means to store instructions, and a second means to execute the instructions to cause the system to perform operations. The operations include to provide a digital sponsored advertisement event exposure payload to a remote server via a publisher server having an integrated media measurement software development kit, wherein the publisher server hosts a website that users access via a network with client devices and the digital sponsored advertisement event exposure payload includes a featured product sensitive to user interactions, to generate a register when a user activates a trigger, wherein the register links the user, the remote server, and the featured product, and to update the register when a transaction associated with the featured product and the user is identified.

These and other embodiments will become clear to those with ordinary skill in view of the following.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture suitable for practicing some implementations of the disclosure.

FIG. 2 illustrates a system to streamline real time events from a publisher webpage in a consumer device to enable sponsored advertisements, according to some embodiments.

FIGS. 3A-3F illustrate screenshots of a retail media network application running in a client device and including sponsored product advertisements, according to some embodiments.

FIG. 4 is a flow chart illustrating steps in a method for tracking sponsored advertisement performance and attribution, according to some embodiments.

FIG. 5 is a flow chart illustrating steps taken via a client side software development kit that is envisioned to be integrated on a website or mobile app or connected TV or digital audio to be able track sponsored advertisement media exposure events, according to some embodiments.

FIG. 6 is a flow chart illustrating steps in a method for tracking sponsored advertisement media exposure events, according to some embodiments.

FIG. 7 is a flow chart illustrating steps in a method for providing a digital payload to a retail network server for tracking advertisement performance and attribution, according to some embodiments.

FIG. 8 is a block diagram illustrating an example computer system with which the client and network device of FIG. 1 and the methods of FIGS. 4-7 can be implemented.

In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Marketing tools used for advertising universal product codes (UPCs) are largely ineffective, as they are typically based on demographic data for users, rather than their personalized purchasing history and habits. In many instances, a brand manufacturer may desire to push a product or a line of products via an advertising campaign, and may desire to sponsor advertisements directly to consumers, via a retail media network. A major drawback for users in the CPG industry is the tenuous correlation between a consumer browsing a retailer network remotely, showing interest on an advertisement (e.g., online advertisement) and an actual purchase of the featured product with a long-time lapse between the two distinct events. Moreover, while the consumer may interact with the product advertisement online, view a follow up brand or promoted product in a physical billboard as they are on the way to work, and they may then proceed to purchase the product while physically present at a retail store. Correlating these events occurring via different channels and at different times is challenging, but desirable. Indeed, regardless of the seeming disconnection between the two media exposure events, the consumer may actually have purchased the featured product under the influence of the advertisement. In fact, it may be a substantial portion of an advertisement campaign success. In addition, it is desirable that an advertisement performance system keep personal identification information (PII) safe from a third party, to guarantee consumer's privacy and security.

The disclosed system addresses this problem specifically arising in the realm of computer technology by providing a solution also rooted in computer technology, namely, by transmitting a digital payload of sponsored media exposure events collected from digital properties like retailer focused websites, mobile apps, connected TV apps, etc., within the context of a retail media network by invoking software code in-moment and in real-time to track the media exposure event and transmit it to a central server for logging and processing. The central server is a part of a measurement service provider network that has access to purchasing information via POS devices at retail stores to provide media attribution and measurement.

The subject system provides several advantages, including the ability to better plan advertising campaigns.

Although many examples provided herein describe a user's inputs being the products that they are browsing in the context of a retail media network via digital properties (web, mobile, connected TV, etc.) and purchasing history being identifiable, or download consumer history, each user may grant explicit permission for such user information to be shared or stored. In some embodiments, a retailer may establish an agreement with consumers registered with a frequent consumer identification to allow tracking of sponsored media advertising content and the upstream purchase based attribution and measurement to take place. In some embodiments, the consumer may opt out from media advertisement attribution tracking with one or more particular retailers. The explicit permission to participate and allow advertisement attribution tracking may be granted using privacy controls integrated into the disclosed system. Each user may be provided notice that such user information will be shared with explicit consent, and each user may at any time terminate the information sharing, and may delete any stored user information. The stored user information may be encrypted to protect user security.

### Example System Architecture

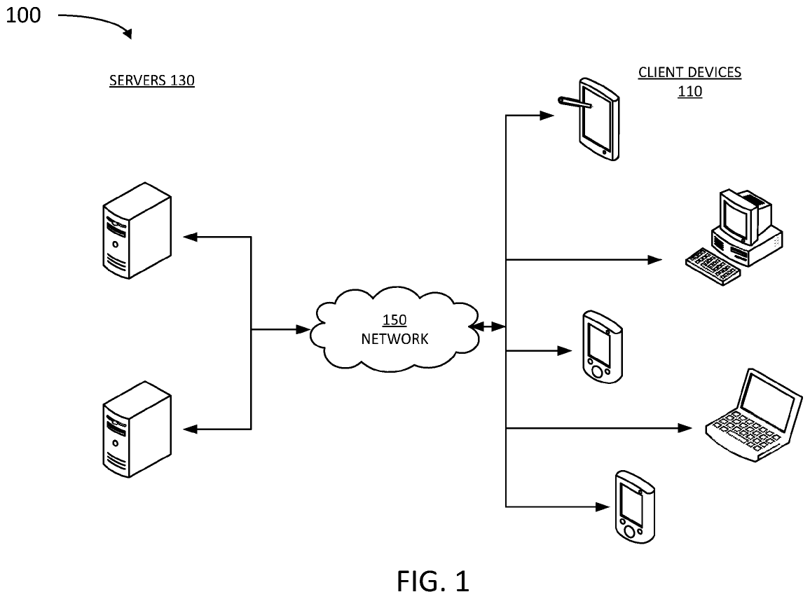

FIG. 1 illustrates an example architecture 100 suitable for practicing some implementations of the disclosure. Architecture 100 includes servers 130 and client devices 110 connected over a network 150. One of the many servers 130 and client devices 110 may include a memory storing instructions which, when executed by a processor, cause the server 130 and the client device 110 to perform at least some of the steps in methods as disclosed herein. In some embodiments, architecture 100 is configured to provide an advertisement payload including personalized advertisements and at least one sponsored advertisement to consumers via client device 110. Upon reaching a trigger event, or per consumer request, one or more of servers 130 may instruct a client device, e.g., a printer at a point-of-sale (POS) or store kiosk, to print a coupon for the consumer based on the advertisement payload. The advertisement payload may be prepared by a user of one of servers 130, based on an advertisement campaign to promote a CPG, or a retailer chain or branch.

Servers 130 may include any device having an appropriate processor, memory, and communications capability for hosting a purchase history log for multiple consumers, an advertisement database, and an advertisement server. The advertisement server may be accessible by various client devices 110 over the network 150. In some embodiments, servers 130 may include a dynamic rendering server, a publisher, or SSP server, and a DSP server. Client devices 110 may include, for example, desktop computers, mobile computers, tablet computers (e.g., including e-book readers), mobile devices (e.g., a smartphone or PDA), or any other devices having appropriate processor, memory, and communications capabilities for accessing one or more of servers 130 through network 150. In some embodiments, client devices 110 may include a Bluetooth radio or a near-field-communication (NFC) transmitter device and application, enabling the client device to communicate directly with another device in its proximity, e.g., a device at a POS in a retail store. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

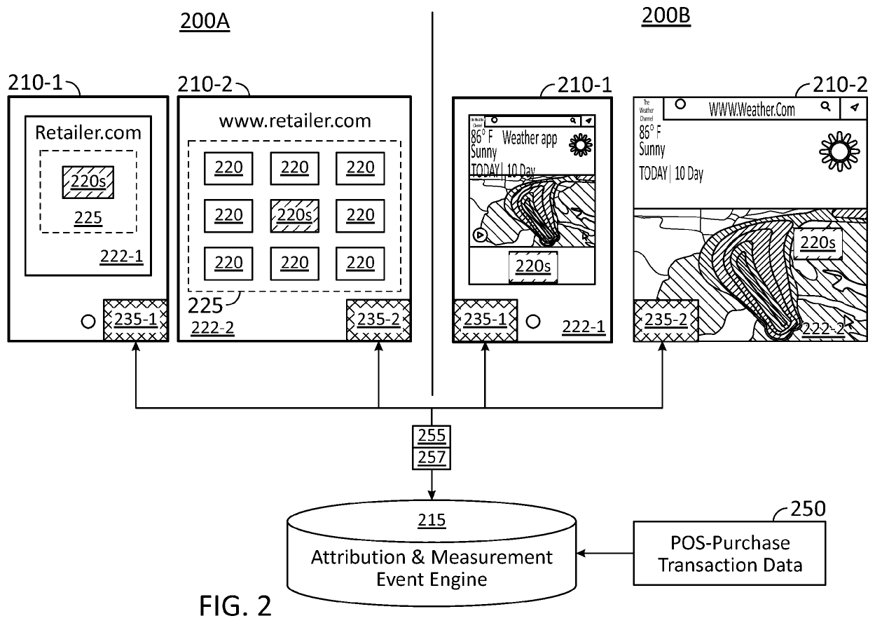

FIG. 2 illustrates a system to streamline real time events from a retailer network 200A (when the consumer explicitly access or is registered to this network) or a publisher webpage 200B (for off retail network consumers) in a consumer device (e.g., a mobile device 210-1 or desktop 210-2, hereinafter, collectively referred to as “consumer devices 210”) to enable sponsored advertisements 220s embedded within other targeted advertisements 220 to be presented to the consumer, according to some embodiments. A retail media network 200A may include a mobile app 222-1, a desktop website 222-2, or any other digital properties or widgets that may be accessed by the consumer while browsing content from a news outlet, or any media content provider (e.g., movies, TV series, games, and other entertainment, hereinafter, collectively referred to as “applications 222”). Accordingly, ad payloads 225 may include a static ad (e.g., a banner ad) or a dynamic, interactive payload or carrousel with multiple product-based advertisements and offers 220 that are personalized and selected for the consumer, or sponsored by a brand manufacturer 220s. The consumer may interact and scroll through ad unit 225 or carrousel and watch/select one or more of the advertised products as desired. A media measurement software development kit (SDK) 235-1 (for a mobile device 210-1) or 235-2 (for a desktop 210-2, hereinafter, collectively referred to as SDKs 235) will passively transmit media exposure events within to a central system (e.g., an attribution and measurement event engine) 215 that will ingest the exposure events, and correlate them to a POS or ecommerce based purchase event 250. The process to pair the media exposure event is not limited to looking up and pairing a device identifier 255 (e.g., a mobile cookie ID or mobile advertising device identifier) and/or consumer context with a retail-specific frequent shopper card ID 257, such as illustrated in Table I, below. In embodiments consistent with the present disclosure, the mobile cookie ID 255 may be a desktop or mobile web, advertising device identifier, which in some embodiments may be different from a mobile device identifier used by a network service provider that services the operating system of the mobile device itself.

TABLE I

| Mobile Cookie ID | Database Retailer's FSC ID |
|---|---|
| hsh192zur94 | 384759 |
| Su928470184 | 495038 |

*Table I values are illustrative for example purposes

A browser or mobile application 222 in the consumer mobile device may invoke a call to the media measurement SDKs 235 to allow it to capture various parameters in the sponsored advertising context, and transmit it to Attribution & Measurement engine 215. Attribution & Measurement engine 215 may be configured to identify the incoming HTTP application programming interface (API) calling from various digital properties (web, mobile app, connected TV app, etc.) within a retailer's media network.

Attribution & Measurement engine 215 may be configured to execute logic commands that use the identifier of a consumer mobile device and crosswalk an ID mapping table (e.g., Table I, above) to look up retailer's FSC ID 257 (frequent consumer identification ID). Attribution & Measurement engine 215 may also be configured to execute internal logic to query retailer's FSC ID 257. Attribution & Measurement engine 215 will then process out a series of attribution and measurement insights for the retailer and advertiser to understand the efficacy of the media ad spend, and incremental sales lift along with several other metrics and insights.

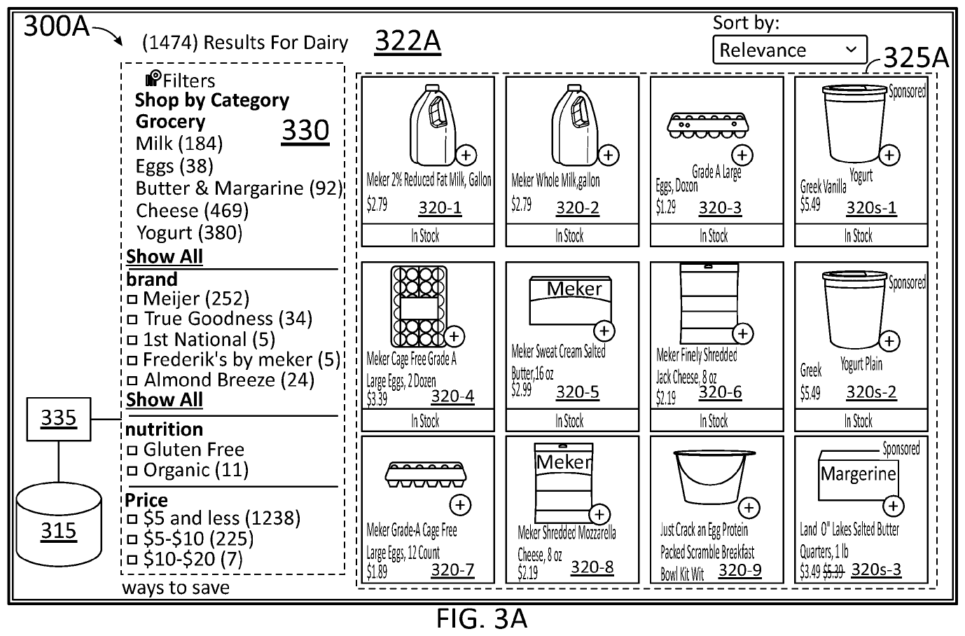

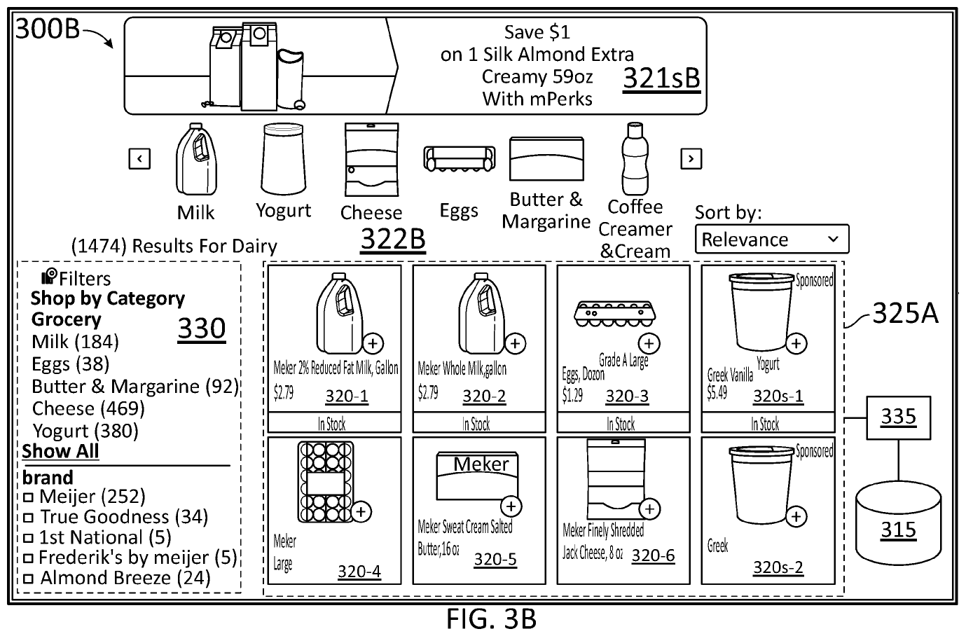

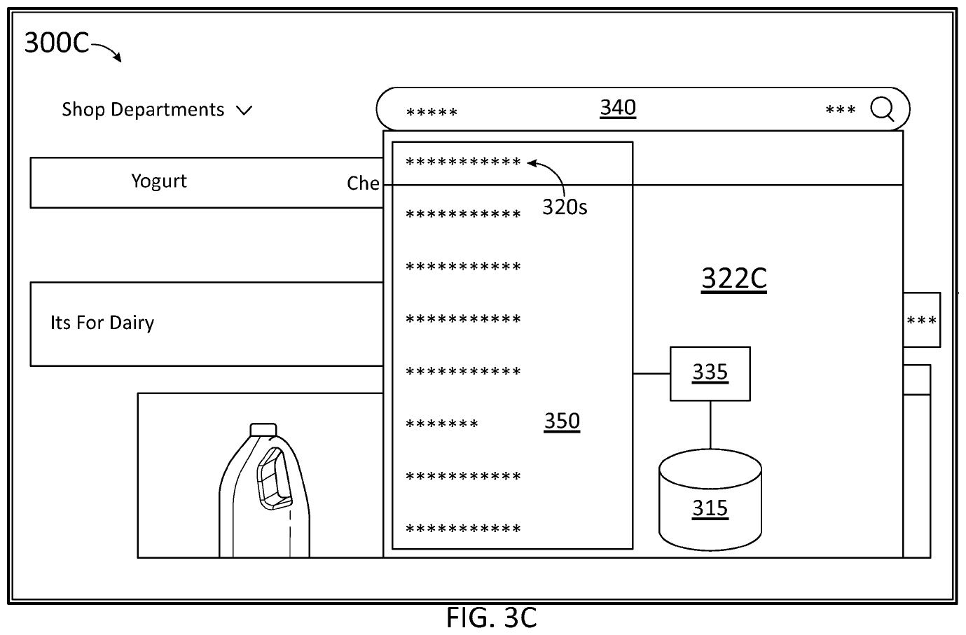

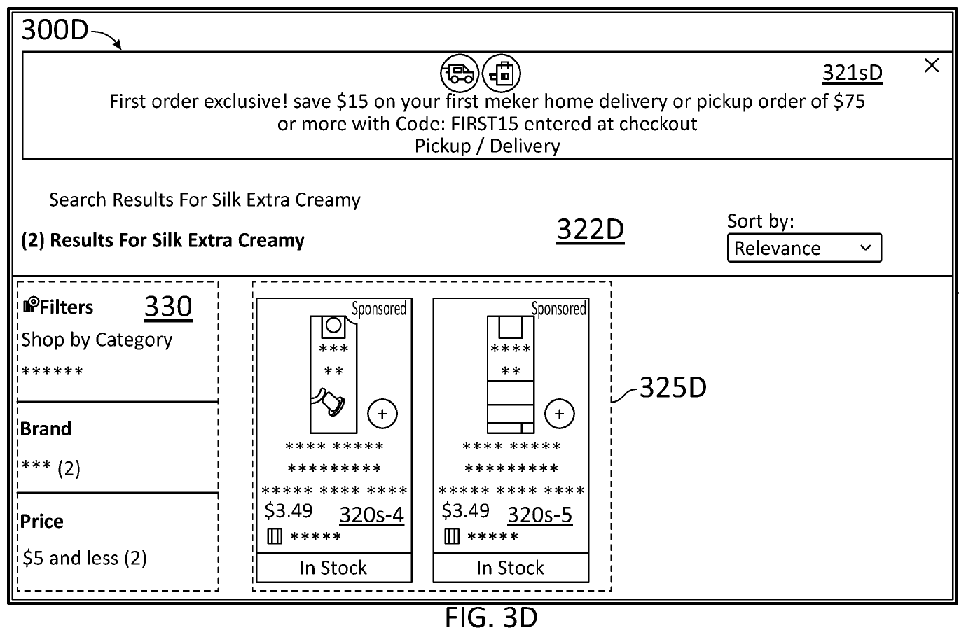

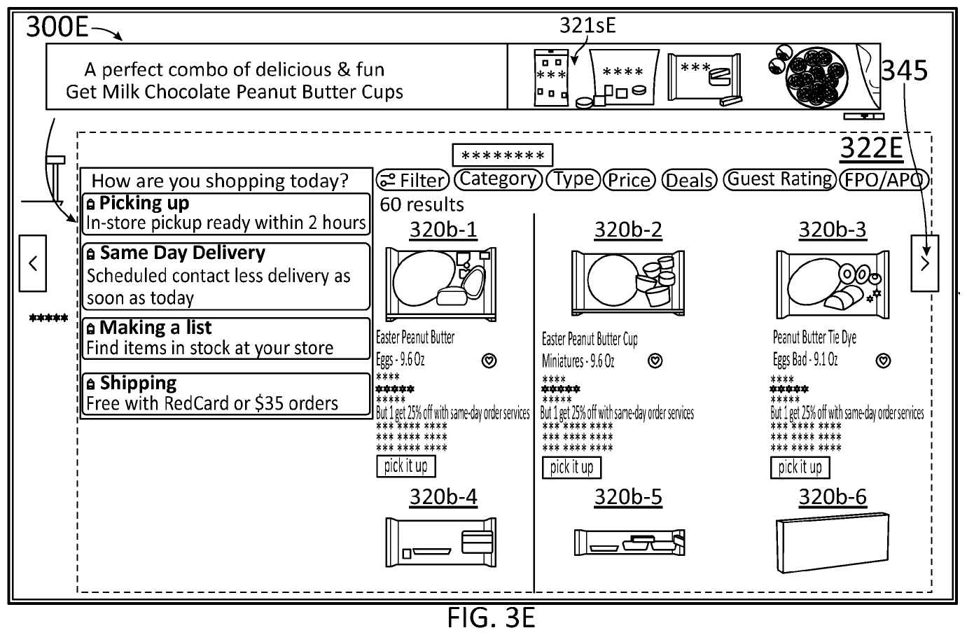

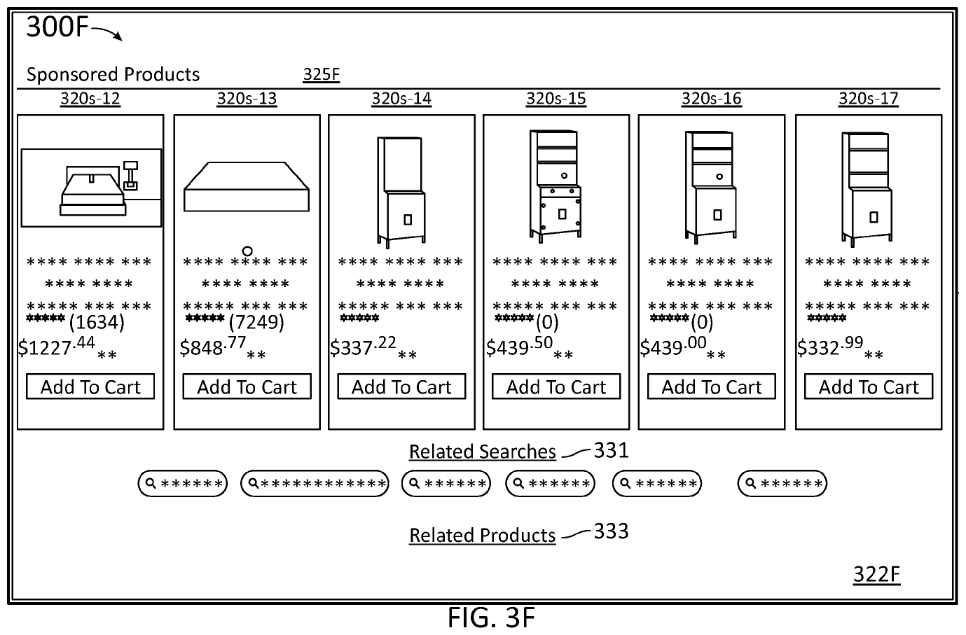

FIGS. 3A-3F illustrate screenshots 300A, 300B, 300C, 300D, 300E and 300F (hereinafter, collectively referred to as “screenshots 300”) of a retail media network application 322A, 322B, 322C, 322D, 322E or 322F (hereinafter, collectively referred to as “applications 322”) running in a client device and including sponsored product advertisements, according to some embodiments. A filter 330 enables the consumer to select search criteria for products in retailer application 322. An SDK 335 transmits sponsored advertising media exposure events including any click stream, add-to-cart, or any other user associated digital event back to an attribution and measurement event engine 315 for attribution and measurement insight purposes.

Screenshot 300A of website 322A illustrates a part of a retailer media network that showcases a digital product shelf of goods 325A and contains sponsored product listing advertisements 320s-1, 320s-2, and 320s-3 (hereinafter, collectively referred to as “sponsored advertisements 320s”), according to some embodiments. In some embodiments, the consumer may be browsing through retail website 322A (e.g., after a search entry for “Dairy”) and access digital product shelf 325A displaying several rows of sponsored product advertisements 320s. In each row, at least one of the advertisements is a sponsored advertisement 320s for a featured product (e.g., a brand of yogurt or margarine), and the rest are targeted advertisements 320-1, 320-2, 320-3, 320-4, 320-5, 320-6, 320-7, 320-8 and 320-9 (hereinafter, collectively referred to as “target advertisement 320”). Sponsored advertisements 320s may include a label explicitly stating that the advertisement within is sponsored by a brand manufacturer to be in the retail website.

Other than sponsored advertisements 320s, the other advertisements 320 may be personalized for each consumer according to purchasing history and the like, as discussed above. In some embodiments, advertisements 320 may be selected by the retail advertisement server according to business rules (e.g., pushing product according to pricing, supply and demand, stock availability and revenue).

Screenshot 300B of website 322B illustrates a part of a retailer media network that showcases a sponsored product banner advertisement 321sB, according to some embodiments. Accordingly, a brand manufacturer may desire to place a banner across the width (or length) of website 322B, for more visibility. In addition, retailer website 322B may include other sponsored advertisements 320s-1 and 320s-2, and non-sponsored advertisements 320.

Screenshot 300C of website 322C illustrates a part of a retailer media network that showcases a sponsored advertisement keyword search, according to some embodiments. When a consumer puts a search query in a search tab 340 of a retailer website 322C, a script in the digital payload provided by the advertisement engine to the retail network server may recognize a featured product in a sponsored advertisement 320s, and list the featured product in an auto-fill menu 350 popping up below search tab 340.

Screenshot 300D of website 322D illustrates a part of a retailer media network that showcases a branded product page advertisement 321sD, according to some embodiments. In some embodiments, when the consumer clicks on a sponsored advertisement, the mobile device may display a full page of branded sponsored advertisements for multiple products 329s-4 and 320s-5, in addition to the sponsored product originally selected by the consumer.

Screenshot 300E illustrates the webpage 322E of a brand manufacturer that is sponsoring a banner advertisement 321sE, according to some embodiments. For example, when the consumer clicks on sponsored banner advertisement 321sE, the mobile device takes the consumer to a landing page 322E hosting brand manufacturer specific products, including advertisements, offers, and deals 320b-1, 320b-2, 320b-3, 320b-4, 320b-5 and 320b-6 (hereinafter, collectively referred to as brand advertisements 320b), featuring multiple products from the brand manufacturer.

Screenshot 300F illustrates a sponsored product carrousel 325F in a website 322F within a retailer media network, according to some embodiments. The consumer may click a scroll arrow 345 and review one or more, or all of the sponsored advertisements in a given section of the retailer website. The consumer may also perform related searches 331 or look for related products 333.

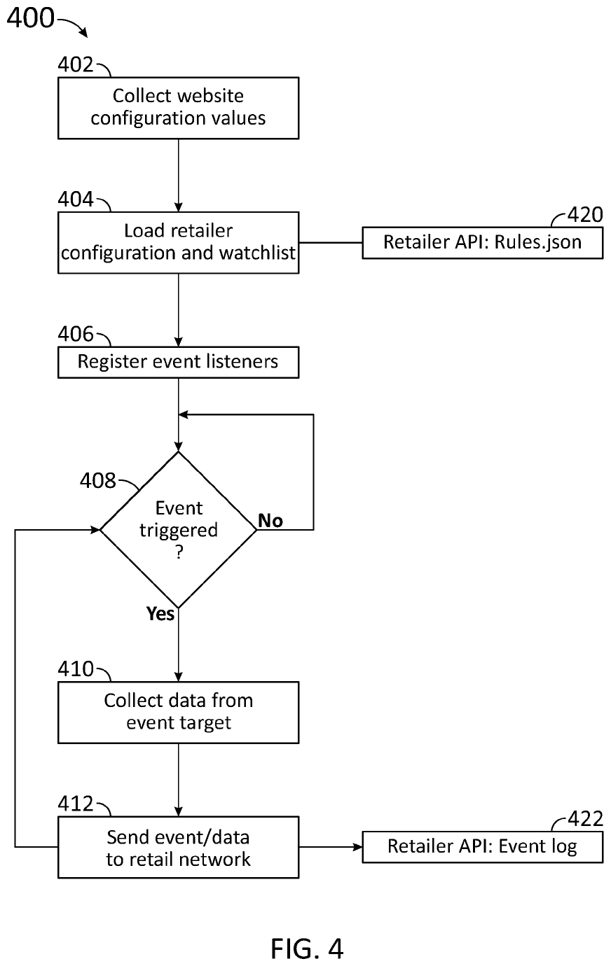

FIG. 4 illustrates steps in a method 400 for tracking sponsored advertisement performance and attribution, according to some embodiments. Method 400 may be performed at least partially by any one of the plurality of servers illustrated in FIG. 1. For example, at least some of the steps in method 400 may be performed by one component in a system, including a retailer or more generally a publisher mobile app integrated with the measurement measurement SDK running code, and an sponsored advertisement engine that processes logic to select an advertisement playlist and push it to the mobile device. Accordingly, at least some of the steps in method 400 may be performed by a processor executing commands stored in a memory of the server, or accessible by the server. Further, in some embodiments, at least some of the steps in method 400 may be performed overlapping in time, almost simultaneously, or in a different order from the order illustrated in method 400. Moreover, a method consistent with some embodiments disclosed herein may include at least one, but not all, of the steps in method 400.

Step 402 includes collecting website configuration values.

Step 404 includes loading the retailer configuration and a watchlist from a rules.json file 420 in the retailer API.

Step 406 includes registering event listeners.

Step 408 includes awaiting until an event is triggered.

Step 410 includes collecting data from the event target when an event is triggered.

Step 412 includes sending the event and data to the retail network, and creating an event log 422 in the retailer API.

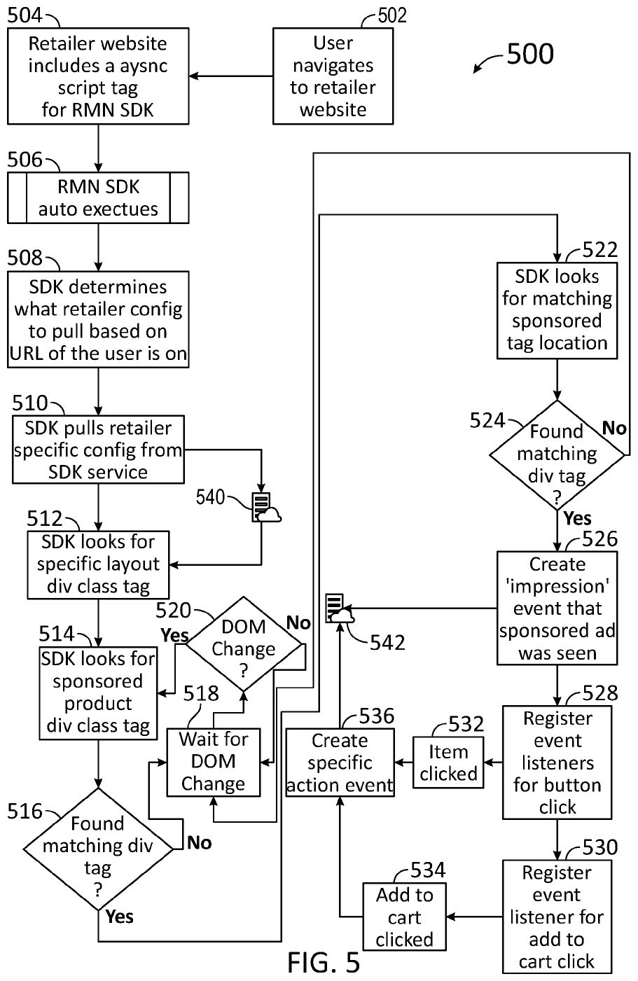

FIG. 5 is a flow chart illustrating steps in a method 500 for collecting digital events from a digital property within the retail media network for the purpose of providing sponsored media advertisement attribution and measurement insights, according to some embodiments. Method 500 may be performed at least partially by any one of the plurality of servers illustrated in FIG. 1. For example, at least some of the steps in method 500 may be performed by one component in a system, including a mobile device running code for a browser and an application to access a publisher website, and an sponsored advertisement engine that processes logic to select an advertisement to push to the mobile device. Accordingly, at least some of the steps in method 500 may be performed by a processor executing commands stored in a memory of the server, or accessible by the server. Further, in some embodiments, at least some of the steps in method 500 may be performed overlapping in time, almost simultaneously, or in a different order than the order illustrated in method 500. Moreover, a method consistent with some embodiments disclosed herein may include at least one, but not all, of the steps in method 500.

In step 502, the user navigates to a retailer website 504 that includes an asynchronous script tag for calling a software development kit (SDK) provided by an advertisement engine.

In step 506, the SDK is automatically executed.

In step 508, the SDK determines a retailer configuration to pull, based on a universal resource locator (URL) address of the consumer.

In step 510, the SDK pulls a selected retailer-specific configuration from a configuration endpoint 540 at the advertisement engine.

In step 512, the SDK looks for a specific layout within a product classification tag.

In step 514, the SDK looks for sponsored products within the product classification tag.

When a matching product classification tag is not found according to step 516, steps 518 and 520 await a domain change on the website before looking for a sponsored product within the product classification (step 514).

When a product classification tag is found in step 516, the SDK looks for a matching sponsored tag location in step 522.

When the matching sponsored tag location is found according to step 524, step 526 includes creating an impression event indicative that the sponsored advertisement has been seen by the consumer.

In step 528, the event listeners that have clicked the sponsored advertisement are registered when the item is clicked 532.

In step 530, the event listeners that have added the sponsored product to a (virtual or real) shopping cart 534 are registered.

In step 534, a specific action event is created and saved at an event endpoint 542 in the advertisement engine.

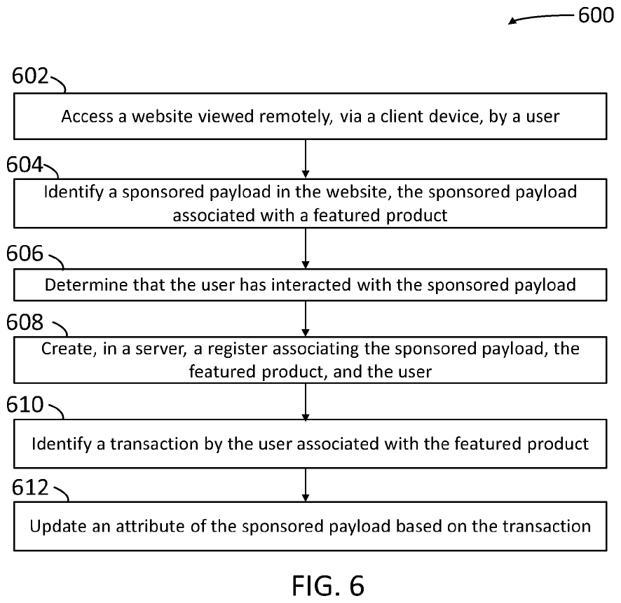

FIG. 6 illustrates steps in a method 600 for tracking sponsored advertisement attribution and measurement, according to some embodiments. Method 600 may be performed at least partially by any one of the plurality of servers illustrated in FIG. 1. For example, at least some of the steps in method 600 may be performed by one component in a system, including a mobile device running code for a browser and an application to access the publisher website, and an advertisement engine that processes logic to select an sponsored advertisement to push the advertisement payload to the mobile device. Accordingly, at least some of the steps in method 600 may be performed by a processor executing commands stored in a memory of the server, or accessible by the server. Further, in some embodiments, at least some of the steps in method 600 may be performed overlapping in time, almost simultaneously, or in a different order from the order illustrated in method 600. Moreover, a method consistent with some embodiments disclosed herein may include at least one, but not all, of the steps in method 600.

Step 602 includes accessing a website viewed remotely, via a client device, by a user. In some embodiments, step 602 includes triggering, on the website, a tracking routine when the user accesses the website. In some embodiments, step 602 includes accessing a browser running in the client device. In some embodiments, step 602 includes accessing a retail media network application running in the client device.

Step 604 includes identifying a sponsored advertisement payload on the website, the sponsored advertisement payload associated with a featured product.

Step 606 includes determining that the user has interacted with the sponsored advertisement payload. In some embodiments, the sponsored advertisement payload is a banner display on a prominent part of a web layout, and step 606 includes determining a hover motion of a pointer device, and a linger time over the banner display. In some embodiments, step 606 includes identifying a click of the user over the sponsored advertisement payload, or a loading of a coupon in the sponsored advertisement payload to a redeeming application or a purchasing application in the client device.

Step 608 includes creating, in a server, a register associating the sponsored advertisement payload, the featured product, and the user. In some embodiments, step 608 includes storing in the register at least one of a location of the sponsored advertisement payload in a web layout of the website, a consumer identification for the user, a brand manufacturer for the featured product, a retailer sponsoring the website, a channel used by the client device to access the website, and a classifier for a type of featured product.

Step 610 includes identifying a transaction by the user associated with the featured product. In some embodiments, step 610 includes identifying that the user has remotely activated the transaction, from a plugin on the website. In some embodiments, step 610 includes receiving a notification from a point-of-sale device at a retail store indicative of the transaction.

Step 612 includes updating an attribute of the sponsored advertisement payload based on the transaction. In some embodiments, step 612 includes at least one of extending a lifetime for the sponsored advertisement payload on the website, or providing a value-added offer to the user for the featured product or for a related product.

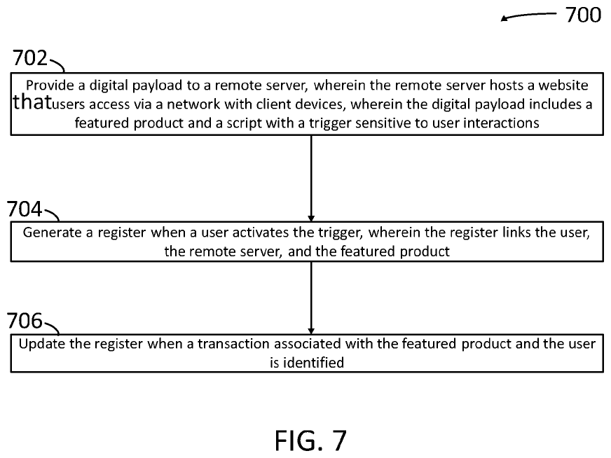

FIG. 7 is a flow chart illustrating steps in a method 700 for using the media measurement SDK to provide a digital sponsored advertisement event exposure payload for tracking sponsored advertisement performance and attribution, according to some embodiments. Method 700 may be performed at least partially by any one of the plurality of servers illustrated in FIG. 1. For example, at least some of the steps in method 700 may be performed by one component in a system, including a mobile device running code for a browser and an application to access a publisher website, and an advertisement engine that processes logic to select an advertisement playlist to push to the mobile device. Accordingly, at least some of the steps in method 700 may be performed by a processor executing commands stored in a memory of the server, or accessible by the server. Further, in some embodiments, at least some of the steps in method 700 may be performed overlapping in time, almost simultaneously, or in a different order than the order illustrated in method 700. Moreover, a method consistent with some embodiments disclosed herein may include at least one, but not all, of the steps in method 700.

Step 702 includes providing a digital payload to a remote server, wherein the remote server hosts a website that users access via a network with client devices, wherein the digital payload includes a featured product and a script with a trigger sensitive to user interactions. In some embodiments, the website includes a search tab, and step 702 further includes providing a name of a sponsored product as a first autofill option when the user clicks the search tab for starting a product search. In some embodiments, the website includes a banner advertisement for a sponsored product from a brand manufacturer, and step 702 further includes landing the user in a brand manufacturer website when the user activates the banner advertisement. In some embodiments, the website is off of a retailer network and the integrated media measurement software development kit provides a mobile identifier for a user device, and step 702 further includes correlating the mobile identifier with a consumer identifier in a retailer network that offers the featured product for sale.

Step 704 includes generating a register when a user activates the trigger, wherein the register links the user, the remote server, and the featured product.

Step 706 includes updating the register when a transaction associated with the featured product and the user is identified. In some embodiments, step 706 includes providing a value-added certificate to the user based on a rule in a retailer network for a retailer that offers the featured product for sale.

### Hardware Overview

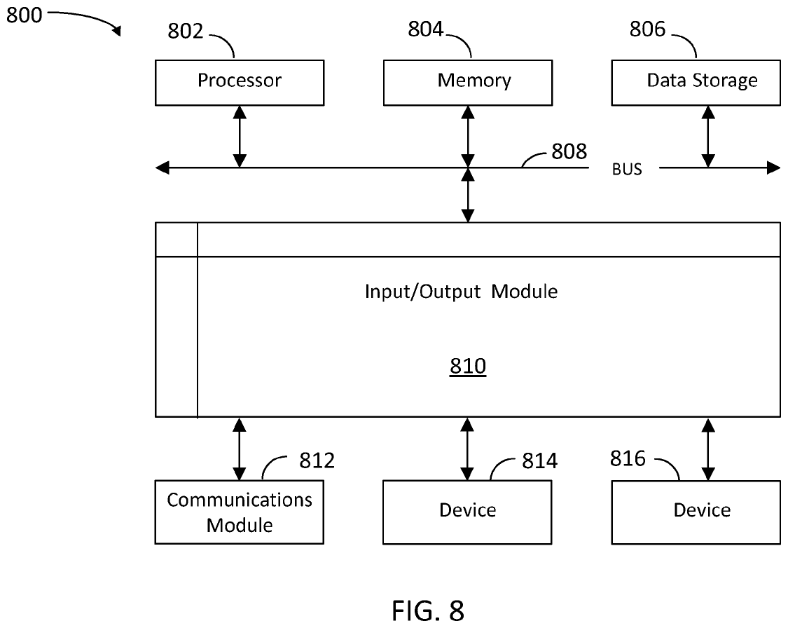

FIG. 8 is a block diagram illustrating an example computer system 800 with which the client and network device of FIG. 1 and the methods of FIGS. 4-7 can be implemented. In certain aspects, computer system 800 may be implemented using hardware or a combination of software and hardware, either in a dedicated network device, or integrated into another entity, or distributed across multiple entities.

Computer system 800 (e.g., client devices 110 and 210-1, and servers 130 and 230) includes a bus 808 or other communication mechanism for communicating information, and a processor 802 coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, e.g., code that constitutes processor firmware, a protocol stack, a database management system, an operating system, or a combination of one or more of them stored in an included memory 804, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. The processor 802 and the memory 804 can be supplemented by, or incorporated in, special purpose logic circuitry.

The instructions may be stored in the memory 804 and implemented in one or more computer program consumer products (e.g., one or more modules of computer program instructions encoded on a computer-readable medium for execution by, or to control the operation of, the computer system 800, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 may be coupled via input/output module 810 to various devices. Input/output module 810 can be any input/output module. Exemplary input/output modules 810 include data ports such as USB ports. The input/output module 810 is configured to connect to a communications module 812. Exemplary communications modules 812 include networking interface cards, such as Ethernet cards and modems. In certain aspects, input/output module 810 is configured to connect to a plurality of devices, such as an input device 814 and/or an output device 816. Exemplary input devices 814 include a keyboard and a pointing device, e.g., a mouse or a trackball, by which a consumer can provide input to the computer system 800. Other kinds of input devices 814 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 816 include display devices, such as an LCD (liquid crystal display) monitor, for displaying information to the user.

According to one aspect of the present disclosure, the client device 110 and servers 130 can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data network device, or that includes a middleware component, e.g., an application network device, or that includes a front-end component, e.g., a client computer having a graphical consumer interface or a Web browser through which a consumer can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 800 can include clients and network devices. A client and network device are generally remote from each other and typically interact through a communication network. The relationship of client and network device arises by virtue of computer programs running on the respective computers and having a client-network device relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires forming bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as “an aspect”, “the aspect”, “another aspect”, “some aspects”, “one or more aspects”, “an implementation”, “the implementation”, “another implementation”, “some implementations”, “one or more implementations”, “an embodiment”, “the embodiment”, “another embodiment”, “some embodiments”, “one or more embodiments”, “a configuration”, “the configuration”, “another configuration”, “some configurations”, “one or more configurations”, “the subject technology”, “the disclosure”, “the present disclosure”, other variations thereof and alike are for convenience and do not imply that a disclosure relating to such phrase(s) is essential to the subject technology or that such disclosure applies to all configurations of the subject technology. A disclosure relating to such phrase(s) may apply to all configurations or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

### Description of Embodiments

Embodiment I. A computer-implemented method includes accessing a website viewed remotely, via a client device, by a user, identifying a sponsored advertisement payload on the website, the sponsored advertisement payload associated with a featured product, determining that the user has interacted with the sponsored advertisement payload, creating, in a server, a register associating the sponsored advertisement payload, the featured product, and the user, identifying a transaction by the user associated with the featured product, and updating an attribute of the sponsored advertisement payload based on the transaction.

Embodiment II. A computer-implemented method includes providing a digital sponsored advertisement event exposure payload to a remote server via a publisher integrated media measurement software development kit, wherein the publisher server hosts a website that users access via a network with client devices, wherein the digital sponsored advertisement event exposure payload includes a featured product sensitive to user interactions, generating a register when a user activates the trigger, wherein the register links the user, the remote server, and the featured product, and updating the register when a transaction associated with the featured product and the user is identified.

Embodiments as disclosed herein may include any one of the embodiments described in Embodiments I and II in combination with any number and permutation of the following elements.

Element 1, wherein accessing a website viewed remotely includes triggering, on the website, a tracking routine when the user accesses the website. Element 2, wherein accessing a website viewed by the user includes accessing a browser running in the client device. Element 3, wherein accessing a website viewed by the user includes accessing a retail media network application running in the client device. Element 4, wherein the sponsored advertisement payload is a banner display on a prominent part of a web layout, and determining that the user has interacted with the sponsored advertisement payload includes determining a hover motion of a pointer device, and a linger time over the banner display. Element 5, wherein determining that the user has interacted with the sponsored advertisement payload includes identifying a click of the user over the sponsored advertisement payload, or a loading of a coupon in the sponsored advertisement payload to a redeeming application or a purchasing application in the client device. Element 6, further including storing in the register at least one of a location of the sponsored advertisement payload in a web layout of the website, a consumer identification for the user, a brand manufacturer for the featured product, a retailer sponsoring the website, a channel used by the client device to access the website, and a classifier for a type of featured product. Element 7, wherein identifying the transaction includes identifying that the user has remotely activated the transaction, from a plugin on the website. Element 8, wherein identifying the transaction includes receiving a notification from a point-of-sale device at a retail store indicative of the transaction. Element 9, wherein updating an attribute of the sponsored advertisement payload includes at least one of extending a lifetime for the sponsored advertisement payload on the website, or providing a value-added offer to the user for the featured product or for a related product.

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, drawings, and the following claims are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method, comprising:
accessing a website viewed remotely, via a client device, by a user;
identifying a sponsored advertisement payload in the website, the sponsored advertisement payload associated with a featured product;
determining that the user has interacted with the sponsored advertisement payload;
creating, in a server, a register associating the sponsored advertisement payload, the featured product, and the user;
identifying a transaction by the user associated with the featured product; and
updating an attribute of the sponsored advertisement payload based on the transaction.

2. The computer-implemented method of claim 1, wherein accessing a website viewed remotely comprises triggering, in the website, a tracking routine when the user accesses the website.

3. The computer-implemented method of claim 1, wherein accessing a website viewed by the user comprises accessing a browser running in the client device.

4. The computer-implemented method of claim 1, wherein accessing a website viewed by the user comprises accessing a retail media network application running in the client device.

5. The computer-implemented method of claim 1, wherein the sponsored advertisement payload is a banner display on a prominent part of a web layout, and determining that the user has interacted with the sponsored advertisement payload comprises determining a hover motion of a pointer device, and a linger time over the banner display.

6. The computer-implemented method of claim 1, wherein determining that the user has interacted with the sponsored advertisement payload comprises identifying a click of the user over the sponsored advertisement payload, or a loading of a coupon in the sponsored advertisement payload to a redeeming application or a purchasing application in the client device.

7. The computer-implemented method of claim 1, further comprising storing in the register at least one of a location of the sponsored advertisement payload in a web layout of the website, a consumer identification for the user, a brand manufacturer for the featured product, a retailer sponsoring the website, a channel used by the client device to access the website, and a classifier for a type of featured product.

8. The computer-implemented method of claim 1, wherein identifying the transaction comprises identifying that the user has remotely activated the transaction, from a plugin in the website.

9. The computer-implemented method of claim 1, wherein identifying the transaction comprises receiving a notification from a point-of-sale device at a retail store indicative of the transaction.

10. The computer-implemented method of claim 1, wherein updating an attribute of the sponsored advertisement payload comprises at least one of extending a lifetime for the sponsored advertisement payload in the website, or providing a value added offer to the user for the featured product or for a related product.

11. A system, comprising:
a memory storing multiple instructions; and
one or more processors configured to execute the instructions and cause the system to:
access a website viewed remotely, via a client device, by a user,
identify a sponsored advertisement payload in the website, the sponsored advertisement payload associated with a featured product,
determine that the user has interacted with the sponsored advertisement payload,
create, in a server, a register associating the sponsored advertisement payload, the featured product, and the user,
identify a transaction by the user associated with the featured product, and
update an attribute of the sponsored advertisement payload based on the transaction.

12. The system of claim 11, wherein to access a website viewed remotely, the one or more processors execute instructions to trigger, in the website, a tracking routine when the user accesses the website.

13. The system of claim 11, wherein to access a website viewed by the user the one or more processors execute instructions to access a browser running in the client device.

14. The system of claim 11, wherein to access a website viewed by the user the one or more processors execute instructions to access a retail media network application running in the client device.

15. The system of claim 11, wherein the sponsored advertisement payload is a banner display on a prominent part of a web layout, and to determine that the user has interacted with the sponsored advertisement payload the one or more processors execute instructions to determine a hover motion of a pointer device, and a linger time over the banner display.

16. A computer-implemented method, comprising:
providing a digital sponsored advertisement event exposure payload to a remote server via a publisher server having an integrated media measurement software development kit, wherein the publisher server hosts a website that users access via a network with client devices and the digital sponsored advertisement event exposure payload includes a featured product sensitive to user interactions;
generating a register when a user activates a trigger, wherein the register links the user, the remote server, and the featured product; and
updating the register when a transaction associated with the featured product and the user is identified.

17. The computer-implemented method of claim 16, wherein the website includes a search tab, further comprising providing a name of a sponsored product as a first autofill option when the user clicks the search tab for starting a product search.

18. The computer-implemented method of claim 16, wherein the website includes a banner advertisement for a sponsored product from a brand manufacturer, further comprising landing the user in a brand manufacturer website when the user activates the banner advertisement.

19. The computer-implemented method of claim 16, wherein the website is off of a retailer network, and the integrated media measurement software development kit provides a mobile identifier for a user device, further comprising correlating the mobile identifier with a consumer identifier in a retailer network that offers the featured product for sale, and providing a value-added certificate to the user when the user activates the trigger.

20. The computer-implemented method of claim 16, wherein updating the register comprises providing a value-added certificate to the user based on a rule in a retailer network for a retailer that offers the featured product for sale.
